(19) United States
(12) Patent Application Publication
(10) Pub. No.: US 2020/0074892 A1
(43) Pub. Date: Mar. 5, 2020

(54) THREE-DIMENSIONAL ATTACHMENT

(71) Applicant: Bret Marsalis Marcot, Miami Beach, FL (US)

(72) Inventor: Bret Marsalis Marcot, Miami Beach, FL (US)

(21) Appl. No.: 16/031,114

(22) Filed: Jul. 10, 2018

(51) Int. Cl. G09F 7/14; G09F 7/12; G09F 7/16

(52) U.S. Cl. CPC G09F 7/14; G09F 2007/127; G09F 7/16; G09F 7/12

(57) ABSTRACT

A three-dimensional attachment. The three-dimensional attachment includes at least one character having a height (h), a width (w) and a depth (d). The at least one character further includes a front surface and a rear surface. The depth (d) extends from the front surface to the rear surface. The depth (d) of the at least one character varies such that the rear surface has a curve contouring to an outer surface of a curved object, and the front surface has a planar design. The three-dimensional attachment thereby attaches to a curved object and the design appears to be three-dimensional relative to the curved object.

### BACKGROUND OF THE INVENTION

The present invention relates to three-dimensional attachments and, more particularly, to three-dimensional attachments that are secured to curved objects.

### SUMMARY OF THE INVENTION

In one aspect of the present invention, a three-dimensional attachment comprises: at least one character comprising a front surface, a rear surface, and a depth extending from the front surface to the rear surface, wherein the depth of the at least one character varies such that the rear surface comprises a curve contouring to an outer surface of a curved object, and the front surface comprises a planar design.

In another aspect of the present invention, a method of securing a three-dimensional attachment to a curved object comprises the steps of: providing the three-dimensional attachment comprising: at least one character comprising a front surface, a rear surface, and a depth extending from the front surface to the rear surface, wherein the depth of the at least one character varies such that the rear surface comprises a curve contouring to an outer surface of a curved object, and the front surface comprises a planar design, and attaching the rear surface of the at least one character to the outer surface of the curved object.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention in use;

FIG. 2 is a front elevation view of an embodiment of the present invention in use;

FIG. 3 is a schematic top view of an embodiment of the present invention being made;

FIG. 4 is a front perspective view of an embodiment of the present invention;

FIG. 5 is a rear perspective view of an embodiment of the present invention; and

FIG. 6 is a flowchart of an embodiment of a method of making the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a curved 3D art that attaches to a curved object, such as a cylinder or sphere. The curved 3D art may be made by using a 3D printer to create a silicone mold and than using the silicone mold to mass produced plastic molds. Using a strong adhesive, the 3D art is adhered to the curved object. The 3D art may include a print of company advertisement, logo, and the like. The curved object may include coconuts, cans, curved billboards, or any curved object.

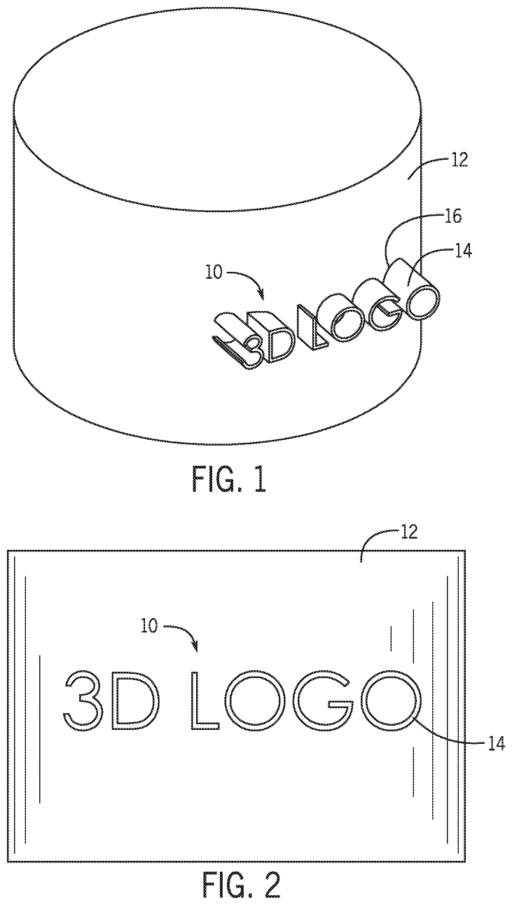

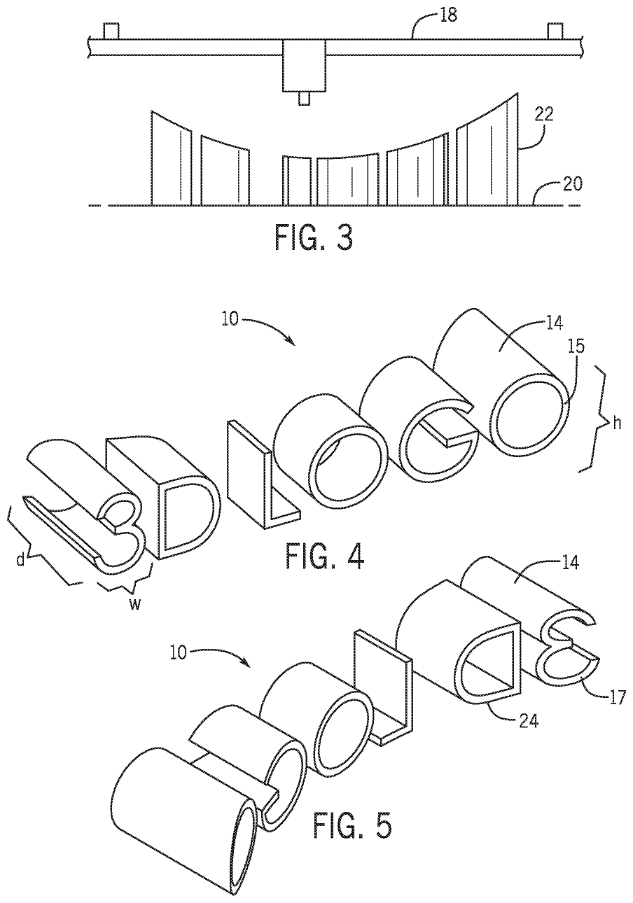

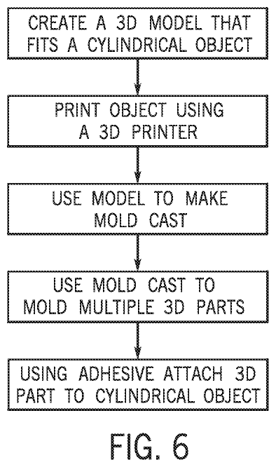

Referring to FIGS. 1 through 6, the present invention includes a three-dimensional attachment 10. The three-dimensional attachment 10 includes at least one character 14 having a height (h), a width (w) and a depth (d). The at least one character 14 further includes a front surface 15 and a rear surface 17. The depth (d) extends from the front surface 15 to the rear surface 17. The depth (d) of the at least one character 14 varies such that the rear surface 17 has a curve contouring to an outer surface of a curved object 12, and the front surface has a planar design. The three-dimensional attachment 10 thereby attaches to a curved object 12 and the design appears to be three-dimensional relative to the curved object 12.

In certain embodiments, the at least one character 14 is a plurality of characters 14. In such embodiments, all of the designs on the front surfaces 15 of each of the characters 14 are planar. The planar design may include at least one of a text, a number, a logo, or a combination thereof.

As mentioned above, the three-dimensional attachment 10 is secured to a curved object 12. In certain embodiments, the rear surface of the characters 14 may include an adhesive 24 that couples the three-dimensional attachment 10 to the curved object 12. The curved object 12 may include a sphere shape, a cylinder shape, or a cone shape.

A method of securing a three-dimensional attachment to a curved object includes the steps of: providing the three-dimensional attachment described above; and attaching the rear surface of the at least one character to the outer surface of the curved object. The step of attaching the rear surface of the at least one character to the outer surface of the curved object includes adhering the rear surface of the at least one character to the outer surface of the curved object with an adhesive.

A method of making the present invention may include the following. Using a 3D printer program, measure the dimensions of the curved object and create a curved prototype file of the the three-dimensional attachment in physical form. A silicone mold cast is then printed using a 3D printer. Once printed, use the mold cast to make plastic three-dimensional attachments in bulk. For example, the mold cast is filled with a two-part plastic filling. Once the plastic filling is dry, the three-dimensional attachment is removed from the mold cast. A strong adhesive attaches the three-dimensional attachments to the curved object.

It should be understood, of course, that the foregoing relates to exemplary embodiments of the invention and that modifications may be made without departing from the spirit and scope of the invention as set forth in the following claims.

1. A three-dimensional attachment comprising:
a plurality of characters each comprising a front surface, a rear surface, and a depth extending from the front surface to the rear surface, wherein the depth of each of the plurality of characters varies such that the rear surface comprises a curve contouring to an outer surface of a curved object and the front surface comprises a planar surface, and wherein, when the plurality of characters are adhered to the outer surface of the curved object, the planar surfaces form a planar design, and a gap disposed within the rear surface of a character of the plurality of characters or between the rear surfaces of multiple characters of the plurality of characters.

2. The three-dimensional attachment of claim 1, wherein the planar design is at least one of a text, numbers, a logo, or a combination thereof.

3. (canceled)

4. The three-dimensional attachment of claim 1, further comprising the curved object.

5. (canceled)

6. A method of securing a three-dimensional attachment to a curved object comprising the steps of:
providing the three-dimensional attachment comprising:
a plurality of characters each comprising a front surface, a rear surface, and a depth extending from the front surface to the rear surface, wherein the depth of each of the plurality of characters varies such that the rear surface comprises a curve contouring to an outer surface of a curved object and the front surface comprises a planar surface; and
a gap disposed within the rear surface of a character of the plurality of characters or between the rear surfaces of multiple characters of the plurality of characters; and
attaching the rear surfaces of each of the plurality of characters the at least one character to the outer surface of the curved object so that the planar surfaces form a planar design.

7. The method of claim 6, wherein the step of attaching the rear surfaces of each of the plurality of characters to the outer surface of the curved object comprises adhering the rear surfaces of each of the plurality of characters to the outer surface of the curved object with an adhesive.

8. The method of claim 6, wherein the planar design is at least one of a text, numbers, a logo, or a combination thereof.

9. (canceled)

10. The method of claim 6, wherein the curved object is at least one of a sphere, a cylinder, and a cone.
